(19) United States
(12) Patent Application Publication
(10) Pub. No.: US 2006/0064216 A1
(43) Pub. Date: Mar. 23, 2006

(54) Automatic steering system

(75) Inventor: Ron Palmer, Regina (CA)

Correspondence Address: FULBRIGHT & JAWORSKI L.L.P., 600 CONGRESS AVE., SUITE 2400, AUSTIN, TX, 78701, US

(73) Assignee: Accutrak Systems Limited

(21) Appl. No.: 11/231,667

(22) Filed: Sep. 21, 2005

(30) Foreign Application Priority Data
Sep. 21, 2004 (CA) 2,482,252

(51) Int. Cl. G06F 19/00

(52) U.S. Cl. 701/41; 701/50

(57) ABSTRACT

An automatic steering system for an agricultural vehicle comprises a steering actuator operative to steer the vehicle in response to a steering signal, and a steering wheel operative to generate and send a manual steering signal to the steering actuator when the steering wheel is turned. A microprocessor is operative to generate and send an automatic steering signal to the steering actuator. A global positioning sensor is operative to determine a sensed location of the vehicle and send a corresponding location signal to the microprocessor, and a gyroscope is operative to determine lateral movement of the vehicle and send a corresponding movement signal to the microprocessor. The microprocessor receives the location signal and the movement signal and compares the sensed location and lateral movement with a desired vehicle path and generates the automatic steering signal. The steering actuator steers the vehicle in response to one of the steering signals.

### BACKGROUND OF THE INVENTION

1. Field of the Invention

This invention is in the field of agricultural vehicles and in particular systems for steering such vehicles automatically.

2. Description of Related Art

Global positioning systems (GPS) are in common use on agricultural tractors, sprayers, and like vehicles. Such systems generally comprise an antenna to pick up signals from satellites circling the globe, and a receiver which translates those signals into location data to establish the location of the vehicle within various tolerances, commonly within inches. The location data is generally transmitted to a microprocessor that can then perform various functions using the GPS data.

The GPS tracks the location of the vehicle over time, and using this location data a microprocessor can provide a steering guide for the vehicle. Typically such agricultural vehicles will be pulling an implement that has a known width, and the object is to cover the entire field by passing back and forth over the field with the edge of the implement located just at the edge of the last pass such that no part of the field is missed, and yet overlap is kept to a minimum.

The width of the implement being used is entered into a microprocessor. The GPS continuously determines the location of the vehicle and the microprocessor tracks and stores the path the vehicle takes as it passes across the field. The microprocessor can thus determine a desired second path adjacent to a first pass by moving the second path over one implement width from the first pass. As the vehicle moves along the field to create the second path, the microprocessor indicates to the vehicle operator the actual location of the vehicle compared to the desired location that is on the second path. In one common system, a light bar is used. A green light in the center of the bar indicates that the vehicle is at the correct location, while yellow lights to each side indicate a variance to the left or right, and the operator steers the vehicle accordingly. Other indicators are also known.

Auto-steering systems have now been developed whereby the microprocessor is used to actually steer the vehicle as opposed to simply indicating to the operator which direction he should steer. Typically the vehicle will be steered by a steering actuator, commonly a hydraulic steering cylinder, that is extended and retracted to steer the vehicle in response to signals from the steering wheel of the vehicle. In an auto-steering system, the microprocessor sends steering signals to the steering actuator. Using the above example of the light bar indicator, when the light is green, the microprocessor steering signal would maintain the actuator in its current position. When a yellow light indicates a variance from the desired location that is on the desired path, the microprocessor steering signal extends or retracts the steering actuator to steer the vehicle toward the desired path. When the GPS senses that the vehicle is at a location that is on the desired path, the microprocessor steering signal would again maintain the actuator in its current position.

In some systems a switch is provided to change the source of the steering signals received by the steering actuator back and forth between the microprocessor and the steering wheel. In others an override is provided such that signals from the steering wheel will override signals from the microprocessor.

When using a conventional auto-steering system, an operator will typically start out by establishing headlands by making a couple of passes at each end of a field to provide an area for turning the vehicle. The operator then strikes out across the field in the direction desired and establishes an AB line from a starting point A to an ending point B. The microprocessor establishes this line as the direction desired and then establishes a grid of desired paths parallel to the AB line and separated by the implement width. The operator will turn at the far end of a pass and when generally aligned in the opposite direction with a desired path, the auto-steering system will be activated to assume control of the steering actuator, either automatically or by switching control from the steering wheel to the microprocessor. Often the auto-steering system will include an audible alarm whereby the microprocessor determines that the previously tracked headland is approaching and warns the operator that he will soon have to make a turn.

A problem with such GPS auto-steering systems is that the GPS signal lags the actual location of the vehicle by a short while, typically 1-3 seconds. Consequently, the microprocessor can only calculate the direction of the vehicle based on where it was compared to where it is at a given time. Vehicle steering systems are not perfect and tend to wander somewhat. Also such vehicle can be pushed off course by hitting a rock, ditch, or the like, and on hillsides gravity will pull them off course as well. Thus when the vehicle is moved off course or wanders, and given the time lag inherent in the GPS, drastic corrections can be sensed and implemented by sending a steering signal to the steering actuator. The result is that steering activity is often jerky as the steering actuator is activated to reposition the vehicle on the desired path. Proportional valves are commonly used with a hydraulic steering cylinder in order to reduce this jerky effect.

### SUMMARY OF THE INVENTION

It is an object of the present invention to provide an auto-steering system that overcomes problems in the prior art.

The present invention provides an automatic steering system for an agricultural vehicle. The system comprises a steering actuator operative to steer the vehicle in response to a steering signal, and a steering wheel operative to generate and send a manual steering signal to the steering actuator when the steering wheel is turned. A microprocessor is operative to generate and send an automatic steering signal to the steering actuator. A global positioning sensor is operative to determine a sensed location of the vehicle and send a corresponding location signal to the microprocessor, and a gyroscope is operative to determine lateral movement of the vehicle and send a corresponding movement signal to the microprocessor. The microprocessor receives the location signal and the movement signal and compares the sensed location and lateral movement with a desired vehicle path and generates the automatic steering signal. The steering actuator steers the vehicle in response to one of the steering signals.

The gyroscope immediately senses lateral movement of the vehicle so that the microprocessor can then determine if the lateral movement was planned, as in a programmed steering correction to maintain the desired path, or unplanned and so caused by faults in the steering system or an obstacle or like occurrence. The microprocessor then sends a corrective automatic steering signal if required based on the lateral movement and whether same was planned. Thus unplanned lateral movements can be quickly detected and corrected, and the time lags inherent in a GPS are reduced.

The present invention provides an automatic steering system that follows a desired path more smoothly and accurately than systems of the prior art.

Conveniently the system is configured such that the automatic steering signals are over-ridden by the manual steering signal, such that the steering wheel can at all times be used to turn the vehicle if required. A low pressure hydraulic circuit can be connected to make the automatic steering corrections, such that a higher pressure in a manual circuit will over-ride the automatic steering signals.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic drawing of an embodiment of the invention;

FIG. 2 is a schematic top view of the operation of an auto-steering system;

FIG. 3 is a schematic top view illustrating the difference between the operation of an auto-steering system of the invention and that of a prior art system.

### DETAILED DESCRIPTION OF THE ILLUSTRATED EMBODIMENTS

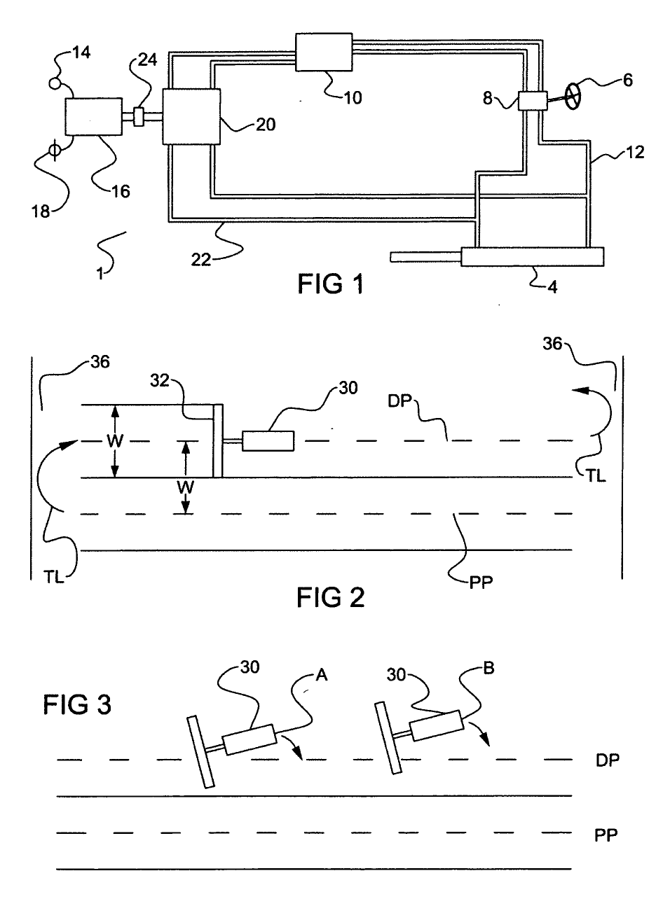

FIG. 1 schematically illustrates an automatic steering system 1 for an agricultural vehicle such as a tractor, self-propelled sprayer, or the like. The system 1 comprises a steering actuator, illustrated in the embodiment of the drawings as a hydraulic steering cylinder 4, that is operative to steer the vehicle in response to a steering signal. Such cylinders 4 are commonly used to steer such vehicles, either by moving the front wheels or by bending a vehicle that uses articulating steering. Conventionally, a steering wheel 6 is operative to generate and send a manual steering signal to the steering actuator when the steering wheel 6 is turned. Although electric or other such actuators receiving electronic steering signals are contemplated for use with the present invention, most conventionally the steering actuator comprises a hydraulic steering cylinder 4 as illustrated. The steering signal in the illustrated system 1 thus comprises a steering flow of pressurized hydraulic fluid that is operative to extend or retract the hydraulic steering cylinder 4 to steer the vehicle.

The steering wheel 6 is connected, either directly or electronically, to a manual steering valve 8 that is supplied from the hydraulic system 10 of the vehicle. A pair of manual hydraulic conduits 12 carry the manual steering flow to the hydraulic steering cylinder 4 from the manual steering valve 8. Turning the steering wheel 6 directs pressurized hydraulic fluid from the manual valve 8 through one of the manual conduits 12 and back through the other, depending on the direction of the turn.

A global positioning sensor 14 is operative to determine a sensed location of the vehicle and send a corresponding location signal to a microprocessor 16. A gyroscope 18 is operative to determine lateral movement of the vehicle and send a corresponding movement signal to the microprocessor 16.

Conveniently the gyroscope 18 can be oriented to spin about a generally horizontal axis to better sense lateral movement. The vehicle turns and changes direction around the gyroscope which remains stable. By measuring the relationship between the stable gyroscope 18 and the vehicle the direction of lateral movement of the vehicle, and the rate or speed of that movement, can be determined immediately and sent to the microprocessor 16. Such gyroscopes 18 require periodic correction to maintain the accuracy of the direction measurement, and so the microprocessor 16 is programmed to calculate a calculated vehicle direction from a plurality of location signals from the global positioning sensor 14, and periodically correct the gyroscope such that the sensed direction of the vehicle corresponds to the calculated vehicle direction.

The microprocessor 16 is programmed to receive the location signal from the global positioning sensor and the movement signal from the gyroscope. The microprocessor 16 then compares the sensed location and lateral movement of the vehicle with a desired vehicle path and generates the automatic steering signal and sends it to the steering actuator. In the illustrated embodiment, the automatic steering signal comprises an electronic signal sent from the microprocessor 16 to an automatic steering valve 20 that converts the electronic signal into an automatic steering flow of pressurized hydraulic fluid through a pair of automatic hydraulic conduits 22 connected to the hydraulic steering cylinder 4.

The steering actuator 4 steers the vehicle 30 in response to one of the steering signals. A switch 24 can be provided that will change the steering operation from manual mode, where the hydraulic steering cylinder 4 receives the manual steering signal from the steering wheel 6, to automatic mode where the hydraulic steering cylinder 4 receives the automatic steering signal from the microprocessor 16. Such a system would require that the operator be always alert when the vehicle is in automatic mode, since if a sudden steering change is required because of an obstacle or the like, turning the steering wheel 6 will not turn the vehicle 30 until the switch 24 is turned to manual mode.

In order to avoid this, the system can be configured such that the steering actuator 4 steers the vehicle 30 in response to the automatic steering signal when no manual steering signal is being generated, and steers the vehicle 30 in response to the manual steering signal when the manual steering signal is being generated. Electronic means can be employed for providing such an over-ride, however in the illustrated embodiment this over-ride is accomplished by maintaining the pressure of the manual steering flow at a significantly greater pressure than the pressure of the automatic steering flow.

Both the manual steering valve 8 and the automatic steering valve 20 are supplied by the hydraulic system 10, however the automatic steering valve 20 includes restrictors to reduce the pressure and flow rate in the automatic hydraulic conduits 22 to a level significantly below the pressure and flow rate present in the manual hydraulic conduits 12. The automatic hydraulic conduits 22 can then be simply teed into the manual hydraulic conduits 12 as illustrated in FIG. 1.

Thus turning the steering wheel 6 and so controlling the higher pressure manual steering flow will always over-ride any lower pressure automatic steering flow controlled by the microprocessor 16 and so steer the vehicle 30 according to the operator's manipulation of the steering wheel. Some back pressure will be felt, but effective control is always available on the steering wheel 6.

A switch 24 is also generally provided to disconnect the microprocessor 16 from the automatic steering valve 20 so that the automatic steering signals are not transmitted to the hydraulic steering cylinder 4. The microprocessor 16 is also programmed such that automatic steering signals will only be generated when the sensed location is within a set distance, for example four feet, of the desired location. Thus when not in the field working, the steering is conventionally controlled by the steering wheel 6.

The lower pressure and reduced flow also result in the hydraulic steering cylinder 4 moving more gradually and thus smoothly in response to the automatic steering flow than when controlled by the higher pressure manual steering flow.

FIG. 2 schematically illustrates the operation of a typical auto-steering system mounted on an agricultural vehicle 30 pulling an implement 32 and moving in direction T. The implement 32 has a width W such that the desired path DP is a distance W from the previous path PP. In FIG. 2 the vehicle 2 is traveling on level land with no obstructions, and illustrates an ideal operation of an auto-steering system.

FIG. 3 schematically illustrates a situation where the vehicle 30 wanders off course, or hits a rock or the like, and moves off the desired path to position A. The movement of the vehicle 30 is somewhat exaggerated for demonstration purposes. The gyroscope immediately senses a lateral movement indicating that the vehicle 30 is turning, and sends a movement signal to the microprocessor.

The microprocessor detects that there has been no location signal from the global positioning sensor indicating that the vehicle 30 is off the desired path DP and so requires a steering correction. The microprocessor thus determines that the movement is not a planned or desirable movement, and sends a steering signal to the steering actuator to steer the vehicle 30 back in a direction opposite to the sensed movement. The rate and amount of movement can be used to determine the approximate correction required, which will be checked against the sensed location from the global positioning sensor.

Since the gyroscope senses the direction change immediately and sends that information to the gyroscope, and the microprocessor processes that information very quickly, only a small steering correction is required. In the illustrated embodiment of FIG. 1, the low pressure, reduced volume automatic steering flow makes that steering correction quite gradual, and the system smoothly steers the vehicle 30 back toward the desired path DP.

With only the global positioning sensor guiding the vehicle 30, the time lag inherent in the GPS will mean that the vehicle 30 will travel off course for a longer period of time before the deviance is detected and correction made, to a point illustrated as point B. At point B the vehicle 30 is farther off course than at point A, and a more drastic correction is required.

The addition of the gyroscope to the system 1 of the invention thus reduces misses and overlaps caused by deviation of the vehicle 30 from the desired path DP. In addition, smaller steering corrections are required resulting in smoother operation.

The microprocessor can be programmed to record a turning location TL where the vehicle 30 changes direction, such as at the headlands 36 adjacent to the ends of the field in FIG. 1, and to activate an alarm when the vehicle 30 next approaches the turning location TL. Thus it is not necessary to make passes at the headland 36, as in the prior art, in order to record the location thereof for warning the operator when the end of a pass is approaching and a turn is required. Often an operator may wish to make the passes to cover the headlands last, and this option is thus available.

Thus the foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. An automatic steering system for an agricultural vehicle, the system comprising:
a steering actuator operative to steer the vehicle in response to a steering signal;
a steering wheel operative to generate and send a manual steering signal to the steering actuator when the steering wheel is turned;
a microprocessor operative to generate and send an automatic steering signal to the steering actuator;
a global positioning sensor operative to determine a sensed location of the vehicle and send a corresponding location signal to the microprocessor;
a gyroscope operative to determine lateral movement of the vehicle and send a corresponding movement signal to the microprocessor;
wherein the microprocessor receives the location signal and the movement signal and compares the sensed location and lateral movement with a desired vehicle path and generates the automatic steering signal; and
wherein the steering actuator steers the vehicle in response to one of the manual steering signal and the automatic steering signal.

2. The system of claim 1 wherein the steering actuator steers the vehicle in response to the automatic steering signal when no manual steering signal is being generated and steers the vehicle in response to the manual steering signal when the manual steering signal is being generated.

3. The system of claim 1 further comprising a mode switch operative, in a manual mode, to connect the steering actuator to receive the manual steering signal and operative, in an automatic mode, to connect the steering actuator to receive the automatic steering signal.

4. The system of claim 1 wherein the microprocessor calculates a calculated vehicle direction from a plurality of location signals, and periodically corrects the gyroscope such that the sensed direction of the vehicle corresponds to the calculated vehicle direction.

5. The system of claim 2 wherein the microprocessor calculates a calculated vehicle direction from a plurality of location signals, and periodically corrects the gyroscope such that the sensed direction of the vehicle corresponds to the calculated vehicle direction.

6. The system of claim 3 wherein the microprocessor calculates a calculated vehicle direction from a plurality of location signals, and periodically corrects the gyroscope such that the sensed direction of the vehicle corresponds to the calculated vehicle direction.

7. The system of claim 1 wherein the gyroscope operates on a substantially horizontal axis.

8. The system of claim 4 wherein the gyroscope operates on a substantially horizontal axis.

9. The system of claim 1 wherein the steering actuator comprises an extendable hydraulic steering cylinder, and the manual steering signal comprises a manual steering flow of pressurized hydraulic fluid operative to extend or retract the hydraulic steering cylinder, and the automatic steering signal comprises an automatic steering flow of pressurized hydraulic fluid operative to extend or retract the hydraulic steering cylinder.

10. The system of claim 2 wherein the steering actuator comprises an extendable hydraulic steering cylinder, and the manual steering signal comprises a manual steering flow of pressurized hydraulic fluid operative to extend or retract the hydraulic steering cylinder, and the automatic steering signal comprises an automatic steering flow of pressurized hydraulic fluid operative to extend or retract the hydraulic steering cylinder.

11. The system of claim 3 wherein the steering actuator comprises an extendable hydraulic steering cylinder, and the manual steering signal comprises a manual steering flow of pressurized hydraulic fluid operative to extend or retract the hydraulic steering cylinder, and the automatic steering signal comprises an automatic steering flow of pressurized hydraulic fluid operative to extend or retract the hydraulic steering cylinder.

12. The system of claim 6 comprising a pair of manual hydraulic conduits operative to carry the manual steering flow to the hydraulic steering cylinder, and a pair of automatic hydraulic conduits operative to carry the automatic steering flow to the hydraulic steering cylinder, and wherein a pressure of the manual steering flow is greater than a pressure of the automatic steering flow such that the manual steering flow will over-ride the automatic steering flow and extend or retract the hydraulic steering cylinder in response to operation of the steering wheel.

13. The system of claim 1 wherein the microprocessor is operative to record a turning location where the vehicle reverses direction, and is further operative to activate an alarm when the vehicle next approaches the turning location.

14. The system of claim 2 wherein the microprocessor is operative to record a turning location where the vehicle reverses direction, and is further operative to activate an alarm when the vehicle next approaches the turning location.

15. The system of claim 3 wherein the microprocessor is operative to record a turning location where the vehicle reverses direction, and is further operative to activate an alarm when the vehicle next approaches the turning location.

16. The system of claim 6 wherein the microprocessor is operative to record a turning location where the vehicle reverses direction, and is further operative to activate an alarm when the vehicle next approaches the turning location.

17. The system of claim 7 wherein the microprocessor is operative to record a turning location where the vehicle reverses direction, and is farther operative to activate an alarm when the vehicle next approaches the turning location.

18. The system of claim 9 wherein the microprocessor is operative to record a turning location where the vehicle reverses direction, and is further operative to activate an alarm when the vehicle next approaches the turning location.

19. The system of claim 12 wherein the microprocessor is operative to record a turning location where the vehicle reverses direction, and is further operative to activate an alarm when the vehicle next approaches the turning location.
